(19) United States
(12) Patent Application Publication
(10) Pub. No.: US 2019/0279600 A1
(43) Pub. Date: Sep. 12, 2019

(54) DRIVING METHOD OF TOUCH DISPLAY DEVICE, TOUCH DISPLAY CONTROL DEVICE AND TOUCH DISPLAY CONTROL METHOD

(71) Applicant: ILI TECHNOLOGY CORP., Hsinchu County (TW)

(72) Inventors: Ping-Yu CHAN, Hsinchu Hsien (TW); Chi Kang LIU, Hsinchu Hsien (TW); Kai-Ting HO, Hsinchu Hisen (TW)

(73) Assignee: ILI TECHNOLOGY CORP., Hsinchu County (TW)

(21) Appl. No.: 16/057,029

(22) Filed: Aug. 7, 2018

(30) Foreign Application Priority Data
Mar. 12, 2018 (TW) 107108237

(51) Int. Cl. G09G 5/12; G06F 3/041

(52) U.S. Cl. CPC G09G 5/12; G06F 3/0416; G06F 3/044; G09G 2310/08; G06F 3/0412

(57) ABSTRACT

A driving method of a touch display device is provided. In a first display period of a first frame time, m gate signals are sequentially provided to first to m^{th} gate lines, respectively, wherein m is a positive integer. In a first touch control period of the first frame time immediately following the first display period, a touch driving signal is provided to a touch sensor. In another first display period of a second frame time immediately following the first frame time, p gate signals are sequentially provided to the first to gate lines, p^{th} respectively, where p is a positive integer and is different from m. In another first touch period of the second frame time immediately following the another first display period, the touch driving signal is provided to the touch sensor.

This application claims the benefit of Taiwan application Serial No. 107108237, filed Mar. 12, 2018, the subject matter of which is incorporated herein by reference.

### BACKGROUND OF THE INVENTION

### Field of the Invention

The invention relates a driving method of a touch display device, a touch display control device and a touch display control method, and more particularly to a driving method of a touch display device, a touch display control device and a touch display control method enabling a touch sensor at different time points in two adjacent frame times.

### Description of the Related Art

With constantly innovating technologies, touch technologies are extensively applied in various consumer electronic products, allowing a user to view an image through a screen as well as inputting an instruction into an electronic device, further achieving an object of human-machine interaction.

In an in-cell touch display device, a touch sensor is directly manufactured in a display panel, such that an in-cell touch display device is thinner compared to other types of touch display devices. Thus, an in-cell touch display device reduces not only the size but also the overall weight to alleviate utilization burden for a user, and has gradually become a mainstream development trend of industry. In an in-cell touch display device, in order to correctly perform a touch function and a display function, a touch sensor and a display panel need to be time-divisionally driven; that is, the operation time of the two is divided into a touch period and a display period that are non-overlapping, so as to prevent the operation of the touch sensor from interfering an image displayed by the display panel.

In a display period of one frame, a display driving control chip sequentially activates shift registers in a gate driving circuit, and provides a display enable signal to the gate driving circuit to sequentially provide a display enable potential to gate lines. Meanwhile, a source driving circuit transmits corresponding data signals to data lines to perform image display. In a touch period, a touch control circuit sequentially transmits a touch driving signal to driving electrodes of a touch sensing element to perform touch sensing. Because touch function and display function cannot be simultaneously performed, the display enable signal is at a display disable potential when touch sensing is performed, so as to halt driving the display panel. To alternately perform image display and touch sensing, a display driving control chip maintains a display enable potential of a display enable signal at a corresponding shift register before it performs touch sensing, and keeps this shift register activated in a touch period and provides a display disable potential to this shift register. Only when the touch period ends, the display driving control chip deactivates this shift register, activates a shift register of a next stage, and provides a display enable potential.

However, a current display driving control chip activates the same shift register in the same touch period corresponding to different frame times, and deactivates the shift register only when the touch period ends, in a way that a turned-on time of a transistor outputting a gate signal in this shift register overlaps this touch period. Thus, the time in which a high-level voltage is applied to the gate of this transistor is far longer than those of transistors of other shift registers. When the in-cell touch display device is used for a period of time, current and voltage characteristics of this transistor of this shift register are likely to drift, hence changing gate signals received by a pixel row corresponding to this shift register as time passes, further affecting the quality of the display image. More particularly, to save cost, a current gate driving circuit is usually integrally fabricated with an array circuit of a display panel in a same thin-film transistor fabrication process. However, thin-film transistors fabricated according to the above method are even more vulnerable to a high-level voltage applied thereto over an extended period of time, characteristics of these thin-film transistors become even more susceptible for drifts, and these thin-film transistors may be damaged. As a result, when the in-cell touch display device performs display, brightness and colors presented by pixel rows corresponding to the changed characteristics do not match those of other pixel rows, leading to an abnormal display image.

### SUMMARY OF THE INVENTION

It is a primary object of the present invention to provide a touch display control device for reducing a drift in characteristics of a transistor as well as preventing shortened durability of a transistor and an abnormal image.

To achieve the above object, the present invention provides a driving method of a touch display device. The touch display device includes a plurality of gate lines and a touch sensor. The driving method includes following steps. In a first display period of a first frame time, m gate signals are sequentially provided to first to m^{th} gate lines, respectively, where m is a positive integer. In a first touch period of the first frame time immediately following the first touch period, the m^{th} gate signal provided to the m^{th} gate line is at a display disable potential, and a touch driving signal is provided to the touch sensor. In another first display period of a second frame time immediately following the first frame time, p gate signals are sequentially provided to the first to p^{th} gate lines, respectively, where p is a positive integer and is different from m. In another first touch period of the second frame time immediately following the another first display period, the p^{th} gate signal provided to the p^{th} gate line is at a display disable potential, and the touch driving signal is provided to the touch sensor.

To achieve the above object, the present invention further provides a touch display control method including following steps. A touch enable signal is generated according to a synchronization signal and a pixel clock signal to control a time point for performing touch detection. A display enable signal is generated according to the touch enable signal to determine time points for respectively enabling a plurality gate lines. Time points at which the touch enable signal enables touch detection in two adjacent frame times are different.

To achieve the above object, the present invention further provides a touch display control device for controlling a touch display device. The touch display device includes a plurality of gate lines. The touch display control device includes a touch enable signal generating circuit and a display enable signal generating circuit. The touch enable signal generating circuit generates a touch enable signal according to a synchronization signal and a pixel clock signal to control a time point for performing touch detection. The display enable signal generating circuit generates a display enable signal according to the touch enable signal to determine time points for respectively enabling the gate lines. Time points at which the touch enable signal enables touch detection in two adjacent frames are different.

In the touch display control device and control method of the present invention, a touch enable signal having different timings in two adjacent frame times is generated. Accordingly, starting time points for enabling a touch sensor are different, thus reducing the time in which a transistor of a shift register of the same stage is continually activated, alleviating a drift in characteristics of the transistor, and preventing shortened durability of the transistor and an abnormal image.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a function block diagram of a touch display device according to an embodiment of the present invention;

FIG. 2 is a schematic section view of a touch display panel according to an embodiment of the present invention;

FIG. 3 is a schematic top view of a touch sensor according to an embodiment of the present invention;

FIG. 4 is a circuit diagram of a touch display panel and a gate driving circuit according to an embodiment of the present invention;

FIG. 5 is a timing diagram of a first frame time of a touch display device according to an embodiment of the present invention;

FIG. 6 is a function block diagram of a touch enable signal generating circuit according to an embodiment of the present invention;

FIG. 7 is a flowchart of a driving method of a touch display device according to a first embodiment of the present invention;

FIG. 8 is a schematic diagram of display periods and touch periods of different frame times of a touch display device according to the first embodiment of the present invention;

FIG. 9 is a timing diagram of a second frame time of a touch display device according to a second embodiment of the present invention; and

FIG. 10 is a schematic diagram of display periods and touch periods of different frame times of a touch display device according to the second embodiment of the present invention.

### DETAILED DESCRIPTION OF THE INVENTION

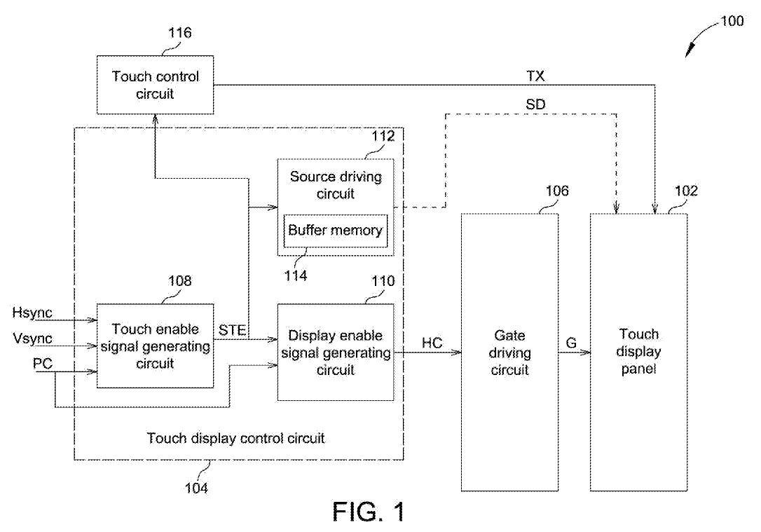

FIG. 1 shows a function block diagram of a touch display device according to an embodiment of the present invention. As shown in FIG. 1, a touch display device 100 of this embodiment includes a touch display panel 102, a touch display control circuit 104 and a gate driving circuit 106. The touch display panel 102 is a panel simultaneously having a touch function and a display function. For example, the touch display panel 102 may be an in-cell or on-cell touch display panel, an out-cell touch display panel, or a hybrid in-cell touch display panel. The gate driving circuit 106 provides a gate signal G for turning on and off pixels of the touch display panel 102. The touch display control circuit 104 receives the synchronization signal and a pixel clock signal PC, and outputs data signals SD according to these signals to the touch display panel 102. The synchronization signal may include a horizontal synchronization signal Hsync and a vertical synchronization signal Vsync. In addition, the touch display control circuit 104 may output a display enable signal HC to the gate driving circuit 106 to control a time point at which the gate driving circuit 106 provides gate signals G to the touch display panel 102, i.e., controlling a time point at which the touch display device 100 performs image display and touch detection.

More specifically, the touch display control circuit 104 may include a touch enable signal generating circuit 108, a display enable signal generating circuit 110 and a source driving circuit 112. The touch enable signal generating circuit 108 generates, according to the synchronization signal and the pixel clock signal PC, a touch enable signal STE indicating when to perform touch detection, so as to control the time point for performing touch detection. In other words, because the time points at which the touch display panel 102 performs image display and touch detection are non-overlapping, the touch enable signal STE may also control the time point for performing image display. Further, time points of the touch enable signal STE enabling touch detection in two adjacent frame times are different. The source driving circuit 112 is electrically connected between the touch display panel 102 and the touch enable signal generating circuit 108, and generates, according to the synchronization signal, the pixel clock signal PC and the touch enable signal STE, a plurality of data signals SD for pixels to display an image. The source driving circuit 112 in this embodiment may include a buffer memory 114 for storing the data signals SD when the touch display panel 102 performs touch detection. In other words, the source driving circuit 112 may determine, according to the touch enable signal STE, whether to transmit the data signals SD to the touch display panel 102, or to store the data signals SD in the buffer memory 114 and transmit the data signals SD to the touch display panel 102 only after the touch detection period ends. The display enable signal generating circuit 110, electrically connected between the gate driving circuit 106 and the touch enable signal generating circuit 108, generates a display enable signal HC according to the pixel clock signal PC and the touch enable signal STE to determine time points for respectively enabling the gate lines, and transmits the display enable signal HC to the gate driving circuit 106. The display enable signal generating circuit 110 may determine whether the display enable signal HC is at a display enable potential or a display disable potential according to the touch enable signal STE to further determine whether to update the display content of the touch display panel 102. The touch display control circuit 104 may be a display driver integrated (DDI) circuit, and the gate driving circuit 106 may be integrated in the display driving integrated circuit or be fabricated on an array substrate of the touch display panel 102.

Further, the touch display device 100 may further include a touch control circuit 116, which outputs a touch driving signal TX to the touch display panel 102 according to the touch enable signal STE to perform touch detection. In another embodiment, the touch control circuit 116 may also be integrated with the touch display control circuit 104 in the same integrated circuit, i.e., into a same touch display driver integrated (TDDI) circuit.

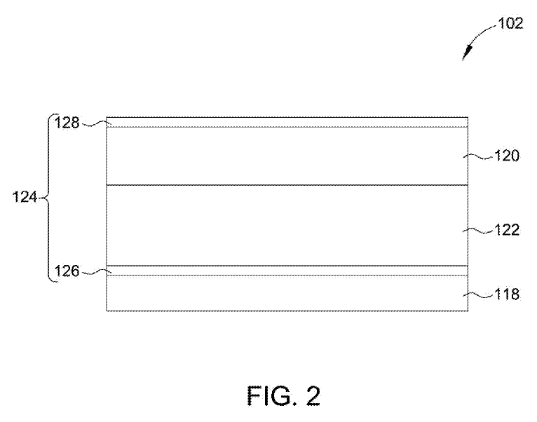

Description is given by taking a hybrid in-cell touch display panel as an example below. However, the present invention is not limited to such example. FIG. 2 shows a schematic section view of a touch display panel according to an embodiment of the present invention. As shown in FIG. 2, the touch display panel 102 of this embodiment includes a first substrate 118, a second substrate 120, a display media layer 122 and a touch sensor 124. The first substrate 118 and the second substrate 120 are disposed at opposite sides, and the display media layer 122 is disposed between the first substrate 118 and the second substrate 120. The first substrate 118 and the second substrate 120 may be formed by transparent substrates, for example but not limited to, glass substrates, reinforced glass substrates, quartz substrates, sapphire substrates or plastic substrates. The material of the display media layer 122 determines the type of the touch display panel. In this embodiment, the display media layer 122 may include, for example but not limited to, a liquid-crystal layer. In other embodiments, the display media layer 122 may also be an organic light-emitting layer, an inorganic light-emitting layer, an electrophoretic display material layer, an electrowetting display material layer, a field emission display material layer or a plasma display material layer.

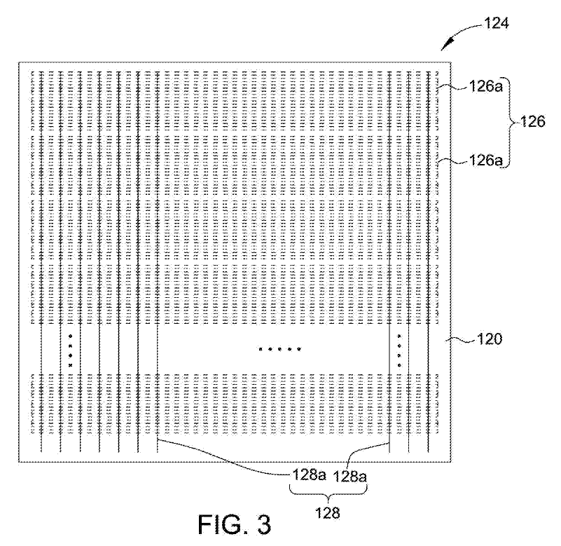

The touch sensor 124 detects a position of a touch object touching or approaching the touch display device 100. In this embodiment, the touch sensor 124 is a mutual capacitive touch sensor, and may include a driving electrode layer 126 and a sensing electrode layer 128. The driving electrode layer 126 may be disposed between the first substrate 118 and the display media layer 122, and the sensing electrode layer 128 is disposed on an outer surface of the second substrate 120. FIG. 3 shows a schematic top view of a touch sensor according to an embodiment of the present invention. As shown in FIG. 3, the driving electrode layer 126 includes a plurality of strip-shaped driving electrodes 126a, the sensing electrode layer 128 includes a plurality of strip-shaped sensing electrodes 128a, and the driving electrodes 126a and the sensing electrodes 128a intersect and are insulated from each other.

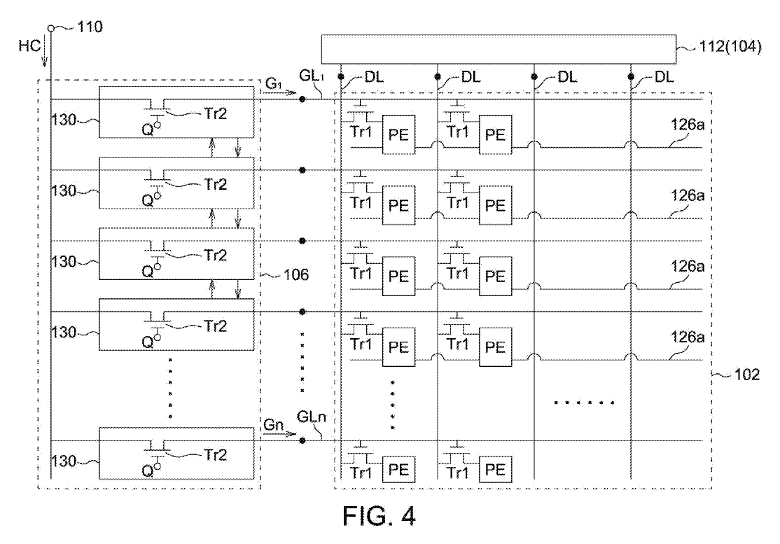

FIG. 4 shows a circuit diagram of a touch display panel and a gate driving circuit according to an embodiment of the present invention. As shown in FIG. 4, the touch display panel 102 may further include a plurality of gate lines GL1 to GLn, a plurality of data lines DL, a plurality of first transistors Tr1 and a plurality of pixel electrodes PE for controlling display of pixels. In this embodiment, the gate lines GL1 to GLn, the data lines DL, the first transistors Tr1 and the pixel electrodes PE may be disposed, for example but not limited to, between the first substrate 118 and the display media layer 122. It should be noted that, the driving electrodes 126a provided between the first substrate 118 and the display media layer 122 further act as common electrodes; that is, the driving electrodes 126a transmit the touch driving signal TX during touch detection and transmit a common voltage during image display. The driving electrodes 126a may cross the data lines DL, and overlap the pixel electrodes PE at the same row to form storage capacitors. Further, the configuration and relationship of the gate lines, data line, first transistors and pixel electrodes of the present invention are not limited to the above examples. One person skilled in the art can appreciate that the gate lines GL1 to GLn, the data lines DL, the first transistors Tr1 and the pixel electrodes PE may have different configurations and connection relationships according to different functions or operations, and such details are omitted herein.

The gate driving circuit 106 may include shift registers 130 in multiple stages. The shift registers 130 are electrically connected to the corresponding gate lines GL1 to GLn, respectively, and output gate signals G1 to Gn to the corresponding gate lines GL1 to GLn, respectively. The shift registers 130 in different stages have the same structure, and any two adjacent shift registers 130 are electrically connected. In this embodiment, the shift register 130 of each stage may include a second transistor Tr2 for outputting the gate signal G. The drain of each second transistor Tr2 is electrically connected to the display enable signal generating circuit 110 to receive the display enable signal HO. The sources of the second transistor Tr2 of the shift registers 130 of different stages electrically connected to the gate lines GL1 to GLn, respectively, to output the gate signals G1 to Gn. More specifically, the shift register 130 of each stage may receive the previous-stage gate signal outputted from the previous-stage shift register 130, pull up the potential at a node Q thereof from a disable potential to an enable potential according to this previous-stage gate signal to turn on the second transistor Tr2, and then output the gate signal of the current stage. Then, the shift register 130 of each stage receives a next-stage gate signal outputted from the next-stage shift register 130 and pull down the potential at the node Q from an enable potential to a disable potential according to this next-stage gate signal to turn off the second transistor Tr2 of the shift register 130 of the current stage, and stops outputting the current-stage gate signal. Further, the gate driving circuit 106 may be disposed, for example but not limited to, on one side of the touch display panel 102. In another embodiment, the touch display device 100 may also include two gate driving circuits 106, which are respectively disposed on two sides of the touch display panel 102, so as to help reducing the time needed for transmitting the gate signals G1 to Gn to the pixels at the corresponding rows. In yet another embodiment, the gate driving circuit 106 and the array circuit may also be fabricated on the first substrate 118 by using the same fabrication process to be further integrated into the same touch display panel 102, i.e., a so-called gate-on-array (GOA) structure.

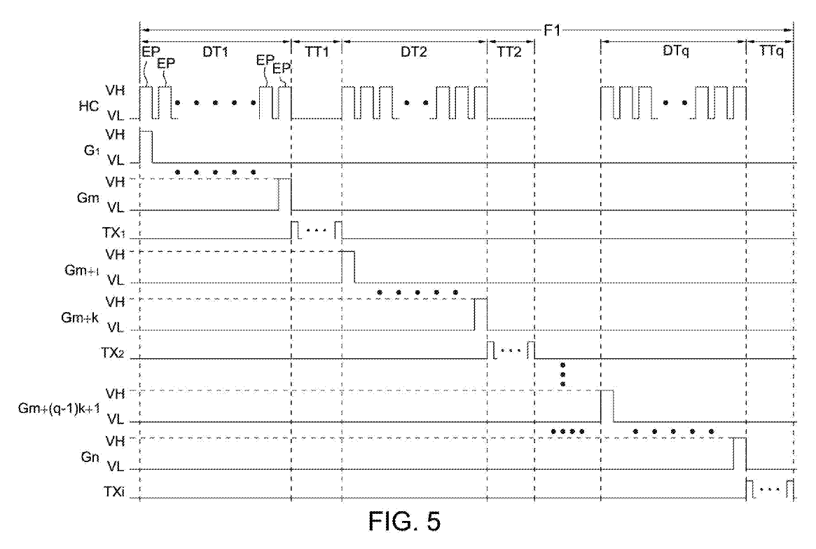

A method of a touch display device displaying an image according to an embodiment of the present invention is described in detail below. Refer to FIG. 5, as well as FIG. 1, FIG. 3 and FIG. 4. FIG. 5 shows a timing diagram of a first frame time of a touch display device according to an embodiment of the present invention. As shown in FIG. 1 to FIG. 3 and FIG. 5, in a first display period DT1 of a first frame time F1, the display enable signal HO transmitted to the gate driving circuit 106 includes a plurality of sequentially generated enable pulses EP. Further, potential levels at the nodes Q of the first-stage to the m^{th}-stage shift registers 130 corresponding to the gate lines GL1 to GLm sequentially rise to an enable potential to sequentially turn on the corresponding second transistors Tr2, such that the shift registers 130 corresponding to the gate lines GL1 to GLm sequentially respectively provide m gate signals G1 to Gm, which are outputted to the first to the m^{th} gate lines GL1 to GLm, wherein m is a positive integer smaller than n. Peaks of the enable pulses PE are at a display enable potential VH, and time lengths of the enable pulses PE are equal to time lengths of the gate signals G1 to Gm at the display enable potential VH. Upon entering a first touch period TT1 of the first frame time F1, the touch enable signal STE of the touch enable signal generating circuit 108 notifies the display enable signal generating circuit 110 that touch control has been entered, and so the display enable signal HO falls from the display enable potential VH to a display disable potential VL, and is maintained at the display disable potential VL in the first touch period TT1. Meanwhile, the touch enable signal STE also notifies the touch control circuit 116 that touch detection has been entered, and so the touch control circuit 116 generates at least one touch driving signal to at least one driving electrode 126a of the touch sensor 124. It should be noted that, in the first touch period TT1, because the m^{th}-stage shift register 130 corresponding to the m^{th} gate lines GLm does not receive the (m+1)^{th} gate signal Gm+1 from the (m+1)^{th}-stage shift register 130, the node Q of the second transistor Tr2 of the m^{th}-stage shift register 130 stays at the enable potential, such that the second transistor Tr2 of the m^{th}-stage shift register 130 remains turned on in this period. Further, since the display enable signal HO drops to the display disable potential VL, the m^{th} gate signal Gm provided by the m^{th}-stage shift register 130 is at the display disable potential VL in the first touch period TT1. Further, in the first touch period TT1, image display data is sequentially transmitted to the source driving circuit 112 along with the pixel clock signal PC. Thus, to prevent the data signals SD from being transmitted in the first touch period TT1, the source driving circuit 112 may first store the corresponding data signals SD in the buffer memory 114 during the first touch period TT1, and then output the data signals SD to the data lines DL of the touch display panel 102 after the first touch period TT1 ends. The capacity of the buffer memory 114 may be determined according to the number of the gate signals at the display enable potential VH in the touch period and the number of the data lines DL. Similarly, in a subsequent touch period, the data signals SD may all be buffered in the buffer memory 114. In a second display period DT2 of the first frame time F1, the touch enable signal STE of the touch enable signal generating circuit 108 notifies the display enable signal generating circuit 110 that image display has been entered, and so the display enable signal HC continues to sequentially generate a plurality of enable pulses EP respectively corresponding to the gate lines GLm+1 to GLm+k, and the nodes Q of the (m+1)^{th}-stage to the (m+k)^{th}-stage shift registers 130 corresponding to the gate lines GLm+1 to GLm+k sequentially rise to the enable potential to sequentially turn on the corresponding second transistors Tr2, such that the shift registers 130 corresponding to the gate lines GLm+1 to GLm+k sequentially respectively generate gate signals Gm+1 to Gm+k, which are sequentially outputted to the corresponding gate lines GLm+1 to GLm+k. It should be noted that, in the second display period DT2, because the m^{th}-stage shift register 130 corresponding to the gate line Gm receives the gate signal Gm+1 from the (m+1)^{th}-stage shift register 130, the node Q of the m^{th}-stage shift register 130 falls from the enable potential to the disable potential to further turn off the second transistor Tr2 thereof. In this embodiment, widths of the enable pulses EP are equal, and the first display period DT1 and the second display period DT2 are the same; that is, k is equal to m. Similarly, in the first frame time F1, the touch display device 100 may perform a second touch period TT2 after the second display period DT2, and sequentially alternately perform a q^{th} display period DTq and a q^{th} touch period TTq, and the first frame time F1 ends only after the gate line GLn has transmitted the gate signal Gn and the i^{th} driving electrode 126a has transmitted a touch driving signal TXi, where q is a positive integer greater than 1 and i is the number of the driving electrodes 126a.

To prevent the node Q of the m^{th}-stage shift register 130 from being repeatedly kept at the enable potential in the first touch period TT1 of different frame times, and hence the gate of the second transistor Tr2 of the m^{th}-stage shift register 130 from excessive damage, the touch enable signal STE generated by the touch enable signal generating circuit 108 of this embodiment may have, in two adjacent frame times, different starting time points for enabling the touch sensor 124 to perform touch detection. That is, in the first touch period TT1 of two adjacent frame times, the nodes Q of shift registers 130 of different stages are kept at the enable potential to shorten the time in which the second transistor Tr2 of the shift register 130 of the same stage is continually turned on, so as to alleviate the drift in characteristics of the second transistor Tr2 and prevent shortened durability.

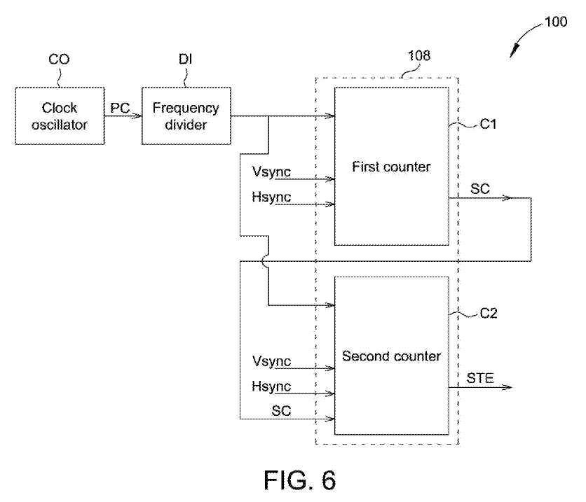

FIG. 6 shows a function block diagram of a touch enable signal generating circuit according to an embodiment of the present invention. As shown in FIG. 6, the touch enable signal generating circuit 108 of this embodiment may include a first counter C1 and a second counter C2 that are electrically connected to each other. The first counter C1 receives a horizontal synchronization signal Hsync, a vertical synchronization signal Vsync and a pixel clock signal PC, generates a frame change signal SC according to these signals, and outputs the frame change signal SC to the second counter C2 to notify the second counter C2 that a different frame time has been entered. The second counter C2 may receive the horizontal synchronization signal Hsync, the vertical synchronization signal Vsync, the pixel clock signal PC and the frame change signal SC, and generate the touch enable signal STE according to these signals. According to the frame change signal SC indicating that a different frame times has been entered, the touch enable signal STE generated by the second counter C2 is correspondingly adjusted, such that the touch enable signal STE of different frame times can have different timings. Thus, the second transistor Tr2 of the shift register 130 of the same stage is prevented from being continually turned on in the same touch period of two adjacent frame times, hence preventing a drift in characteristics of the second transistor Tr2 and alleviating the issue of shortened durability. Further, because both of the first counter C1 and the second counter C2 receive the horizontal synchronization signal Hsync, the vertical synchronization signal Vsync and the pixel clock signal PC, the first counter C1 and the second counter C2 have a same clock reference point for computation, thus preventing clock errors.

In this embodiment, the touch display device 100 may selectively include a clock oscillator CO and a frequency divider DI. The clock oscillator CO provides the pixel clock signal PC. The frequency divider DI is electrically connected between the clock oscillator CO and the touch enable signal generating circuit 108 to decrease the frequency of the pixel clock signal PC, accordingly reducing the operation loads on the first counter C1 and the second counter C2 of the touch enable signal generating circuit 108.

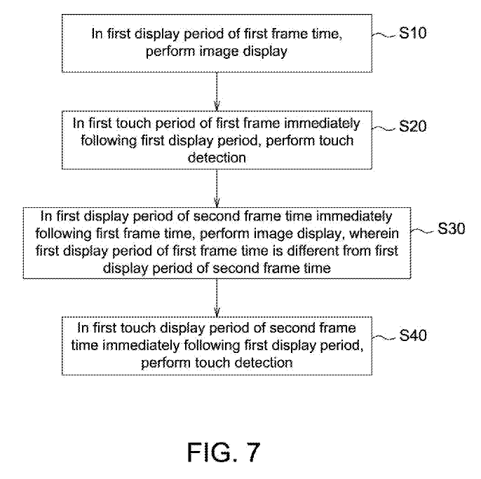

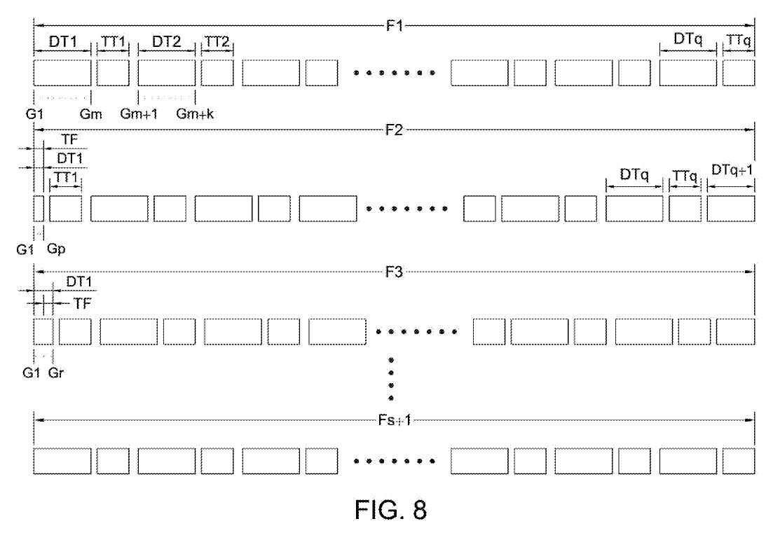

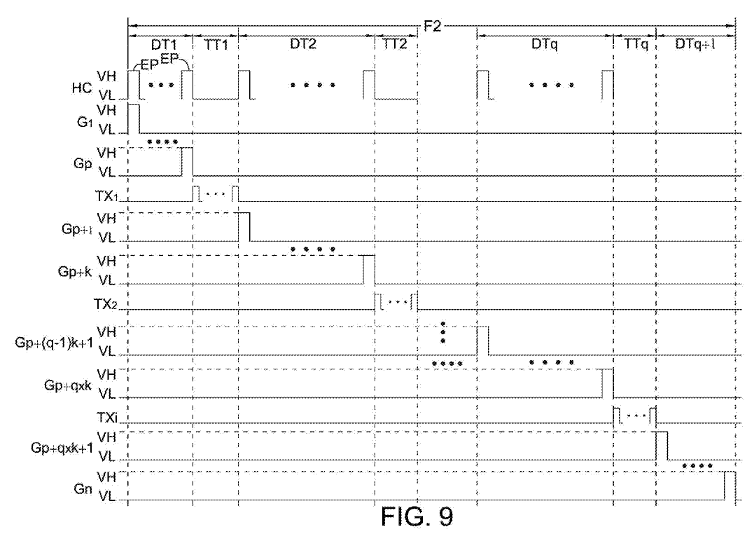

Operation details of the second counter C2 and the driving method of the touch display device of this embodiment are further given below. Refer to FIG. 7 to FIG. 9 and FIG. 5. FIG. 7 shows a flowchart of a driving method of a touch display device according to a first embodiment of the present invention. FIG. 8 shows a schematic diagram of display periods and touch periods of different frame times of a touch display device according to the first embodiment of the present invention. FIG. 9 shows a timing diagram of a second frame time of a touch display device according the first embodiment of the present invention. As shown in FIG. 5, FIG. 7 and FIG. 8, the driving method of the touch display device 100 provided by this embodiment includes following steps. In step S10, in the display period DT1 of the first frame time F1, image display is performed. In step S20, in a first touch period TT1 of the first frame time F1 immediately following the first display period DT1, touch detection is performed. The first frame time F1 may be as shown in FIG. 5 and described previously, and such repeated details are omitted herein.

As shown in FIG. 9, in step S30, in the first display period DT1 of a second frame time F2 immediately following the first frame time F1, image display is performed. The length of the first display period DT1 of the first frame time F1 is different from the length of the first display period DT1 of the second frame time F2. More specifically, in the first display period DT1 of the second frame time F2, the second counter C2 may generate, according to the frame change signal SC, a touch enable signal enabling the touch sensor 124 to perform touch sensing from a different starting time point. Accordingly, the display enable signal HC generated has a different number of enable pulses EP from that of the first display period DT1 of the first frame time F1, such that the length of the first display period DT1 of the second frame time F2 may be different from the length of the first display period DT1 of the first frame time F1. That is to say, given that the time lengths of the gate signals G1 to Gn are equal, the number of the gate signals G1 to Gm of the first display period DT1 of the first frame time F1 is different from the number of the gate signals G1 to Gp of the first display period DT1 of the second frame time F2, where p is a positive number smaller than n and is different from m. In this embodiment, the first display period DT1 of the first frame time F1 is equal to another second display period DT2 or the q^{th} display period DTq of the first frame time F1. When the first frame time F1 is switched to the second frame time F2, the second counter C2 resets the first display period DT1 to zero and adds a fixed time TF, in a way that the fixed time TF acts as the first display period DT1 of the second frame time F2, as shown in FIG. 8. In another embodiment, when the first display period DT1 is different from the second display period DT2 or the q^{th} display period DTq, the second counter C2 adds the fixed time TF to the first display period DT1 of the first frame time F1 to serve as the first display period DT1 of the second frame time F2. Thus, in the first display period DT1 of the second frame time F2, the gate driving circuit 106 sequentially provides p gate signals G1 to Gp to the first to the p^{th} gate lines GL1 to GLp, respectively.

In step S40, in a first touch period TT1 of the second frame time F2 immediately following the first display period DT1, touch detection is performed. In this embodiment, the length of the first touch period TT1 of the second frame time F2 is equal to the length of the first touch period TT1 of the first frame time F1. Similarly, in the second frame time F2, the touch display device may sequentially alternately perform the q^{th} display period DTq and the q^{th} touch period TTq after the second touch period TT2. It should be noted that, because the first display period DT1 of the second frame time F2 is smaller than the first display period DT1 of the first frame time F1 in this embodiment, the touch display device 100 performs the (q+1)^{th} display period DTq+1 after the q^{th} touch period TTq, so as to transmit the remaining gate signals Gp+q×k+1 to Gn to the gate lines GLp+q×k+1 to GLn. The total of the (q+1)^{th} display period DTq+1 and the first display period DT1 of the second frame time F2 is equal to the first display period DT1 of the first frame time F1.

Referring to FIG. 8, the touch display device 100 may proceed to a third frame time F3 immediate following the second frame time F2. In this embodiment, in the first display period DT1 of the third frame time F3, the gate driving circuit 106 sequentially provides r gate signals G1 to Gr to the first to the r^{th} gate lines GL1 to GLr, respectively, wherein r is a positive integer smaller than n and is twice of p. In other words, the second counter C2 adds the fixed time TF (i.e., the first display period DT1 of the second frame time F2) to the first display period DT1 of the second frame time F2 to serve as the first display period DT1 of the third frame time F3. It should be noted that, in this embodiment, the first display period DT1 of the first frame time F1 may be s times of the added fixed time TF, such that, in the (s+1)^{th} frame time, the first display period DT1 is equal to the first display period DT1 of the first frame time F1, and the lengths of the first display period DT1 of the subsequent frame times can sequentially alternate, where s is a positive integer greater than 1.

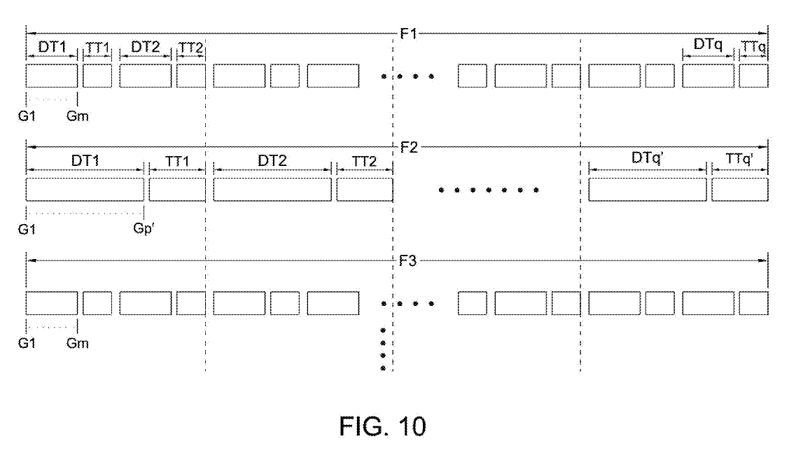

FIG. 10 shows a schematic diagram of display periods and touch periods of different frame times of a touch display device according to a second embodiment of the present invention. For easy comparison, the first frame time of this embodiment is equal to the first frame time of the above embodiment, and associated details are omitted herein. Referring to FIG. 10 as well as FIG. 5, the driving method of this embodiment differs from the first embodiment in that, the first display period DT1 and the first touch period TT1 of the second frame time F2 in this embodiment are respectively multiple times of the first display period DT1 and the first touch period TT1 of the first frame time F1. In other words, in the first display period DT1 of the second frame time F2, the second counter C2 increases the first display period DT1 of the first frame time F1 by multiple times to serve as the first display period DT1 of the second frame time F2, such that the gate driving circuit 106 sequentially provides p′ gate signals G1 to Gp′ to the first and p′^{th} gate lines GL1 to GLp′, respectively, where p′ is multiple times of m. For example, p′ may be twice of m. Then, in the first touch period TT1 of the second frame time F2, the second counter C2 also increase the first touch period TT1 of the first frame time F1 to multiple times as the first touch period TT1 of the second frame time F2, such that the increased ratio of the first display period DT1 is equal to the increased ratio of the first touch period TT1, accordingly preventing a specific touch period from being different from other touch periods. In this embodiment, after the first touch period TT1 of the second frame time F2, the q′^{th} display period DTq′ and the q′^{th} touch period TTq′ are respectively equal to the first display period DT1 and the first touch period TT1 of the second frame time F2. The first display period DT1 and the first touch period TT1 of the second frame time F2 are respectively multiple times of the first display period DT1 and the first touch period TT1 of the first frame time F1, and therefore, the number of the display periods and the number of the touch periods in the second frame time F2 are smaller than the number of display periods and the number of touch periods in the first frame time F1; that is, q′ is different from q. For example, when p′ is twice of m, q is twice of q′.

Further, when p′ is twice of m, the first display period DT1 of the third frame time F3 immediately following the second frame time F2 may be equal to the first display period DT1 of the first frame time F1; that is, the gate driving circuit 106 sequentially provides m gate signals G1 to gm to the first to m^{th} gate lines GL1 to GLm in this period, respectively. Further, the first touch period TT1 of the third frame time F3 may also be equal to the first touch period TT1 of the first frame time F1. That is to say, the first frame time F3 is equal to the first frame time F1. However, the present invention is not limited to the above example. In another embodiment, the first display period DT1 of the first frame time F3 may be multiple times of the first display period DT1 of the second frame time F2, or the first display period DT1 of the third frame time F3 may be multiple times of the first display period DT1 of the first frame time F1, and the increased times of the first display period DT1 of the third frame time F3 is different from the increased times of the first display period DT1 of the second frame time F2.

In conclusion, in the touch display control device and method of the present invention, touch enable signals having different timings are generated in two adjacent frame times. Thus, the starting time point for enabling a touch sensor to perform touch detection in two adjacent frame times are different, thus reducing the time in which a shift register of the same stage is continually turned on, further alleviating a drift in characteristics of a transistor and preventing shortened durability of the transistor and an abnormal image.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving method of a touch display device, the touch display device comprising a plurality of gate lines and a touch sensor, the driving method comprising:
in a first display period of a first frame time, sequentially providing m gate signals to first to m^{th} of the plurality of gate lines, respectively, where m is a positive integer;
in a first touch period of the first frame time immediately following the first display period, providing a touch driving signal to the touch sensor, wherein the m^{th} gate signal provided to the m^{th} gate line in the first touch period of the first frame time is at a display disable potential;
in another first display period of a second frame time immediately following the first frame time, sequentially providing p of the gate signals to the first and p^{th} of the plurality of gate lines, wherein p is a positive integer and is different from m; and
in another first touch period of the second frame time immediately following the another first display period, providing the touch driving signal to the touch sensor, wherein the p^{th} gate signal provided to the p^{th} gate line in the another first touch period of the second frame time is at the display disable potential.

2. The driving method of a touch display device according to claim 1, wherein the another first display period is multiple times of the first display period, and the first touch period is equal to the another first touch period.

3. The driving method of a touch display device according to claim 2, further comprising, in another first display period of a third frame time immediately following the second frame time, sequentially providing r gate signals to the first to r^{th} of the plurality of gate lines, where r is a positive integer and is twice of p.

4. The driving method of a touch display device according to claim 1, wherein a q^{th} display period and a q^{th} touch period of the first frame time are performed after the first touch period, another q^{th} display period and another q^{th} touch period of the second frame time are performed after the another first touch period, and the first display period is equal to the q^{th} display period, where q is a positive integer greater than 1.

5. A touch display control method, for controlling a touch display device, the touch display device comprising a plurality of gate lines, the touch display method comprising:
generating a touch enable signal according to a synchronization signal and a pixel clock signal to control a time point for performing touch detection; and
generating a display enable signal according to the touch enable signal to determine time points for respectively enabling the plurality of gate lines;
wherein, time points at which the touch enable signal enables the touch detection in two adjacent frames are different.

6. The touch display control method according to claim 5, wherein the step of generating the touch enable signal comprises:
generating a frame change signal according to the synchronization signal and the pixel clock signal by a first counter; and
generating the touch enable signal according to the synchronization signal, the pixel clock signal and the frame change signal by a second counter.

7. The touch display control method according to claim 5, further comprising:
outputting a plurality of data signals according to the touch enable signal, and buffering the corresponding data signals in a buffer memory when the touch detection is enabled.

8. A touch display control device, for controlling a touch display device, the touch display device comprising a plurality of gate lines, the touch display method comprising:
a touch enable signal generating circuit, generating a touch enable signal according to a synchronization signal and a pixel clock signal to control a time point for performing touch detection; and
a display enable signal generating circuit, generating a display enable signal according to the touch enable signal to determine time points for respectively enabling the plurality of gate lines;
wherein, time points at which the touch enable signal enables the touch detection in two adjacent frames are different.

9. The touch display control device according to claim 8, wherein the touch enable signal generating circuit comprises:
a first counter, generating a frame change signal according to the synchronization signal and the pixel clock signal; and
a second counter, generating the touch enable signal according to the synchronization signal, the pixel clock signal and the frame change signal.

10. The touch display control device according to claim 8, further comprising:
a source driving circuit, outputting a plurality of data signals according to the touch enable signal, the source driving circuit comprising a buffer memory and buffering the corresponding data signals according to the touch enable signal when the touch detection is enabled.

11. The touch display control device according to claim 8, further comprising:
a clock generating circuit, providing the pixel clock signal; and
a frequency divider, electrically connected between the clock generating circuit and the touch enable signal generating circuit, reducing a frequency of the pixel clock signal.
